(19) United States
(12) Patent Application Publication
(10) Pub. No.: US 2005/0035946 A1
(43) Pub. Date: Feb. 17, 2005

(54) [OPTICAL MOUSE]

(75) Inventor: Yung-Hui Wang, TAIPEI (TW)

Correspondence Address: PATEN WIRELESS TECHNOLOGY INC., 2F-4, NO. 148, SEC. 4, CHUNG HSIAO EAST ROAD, TAIPEI, TW

(73) Assignee: PATENT WIRELESS TECHNOLOGY INC., TAIPEI (TW)

(21) Appl. No.: 10/710,195

(22) Filed: Jun. 25, 2004

(30) Foreign Application Priority Data
Aug. 13, 2003 (TW) 092214668

(51) Int. Cl. G09G 5/08

(52) U.S. Cl. 345/163

(57) ABSTRACT

An optical mouse includes a housing holding a refractor and a circuit board carrying a light emitting element and a sensor, the refractor having a recessed receiving chamber that accommodates the light emitting element, a reflection surface for reflecting light from the light emitting element onto the contact surface that supports the housing, a light penetrating portion, and a circular arc surface for focusing light from the contact surface onto the sensor through the light penetrating portion.

### CROSS REFERENCE TO RELATED APPLICATIONS

This application claims the priority benefit of Taiwan patent application number 092214668 field on Aug. 13, 2003.

### BACKGROUND OF INVENTION

1. Field of the Invention

The present invention relates to an optical mouse for controlling the positioning of a cursor on a display screen and more particularly, to such an optical mouse that effectively reduces loss of light source and, greatly improves light source focusing effect.

2. Description of the Related Art

A mouse is one of the standard peripheral apparatus of a computer system. More particularly to a windows operating system user, a mouse is the requisite input device. Conventionally, a mouse is a mechanical design that carries a ball. The ball has a part protruding over the bottom wall of the housing of the mouse in contact with an external surface (for example, the surface of the top of a desk). When moving the mouse on a flat surface, the ball is forced to rotate and to touch X-axis and Y-axis detecting mechanisms of a detector. The detector converts the moving direction and distance of the ball into a corresponding electric signal and then inputs the signal into the computer. This design of mechanical mouse is not satisfactory in function because the ball tends to carry dust to the mechanical mechanisms of the detector. The mechanical mechanisms fail to function well when covered with dust. In order to eliminate this problem, optical mice are developed.

FIG. 6 shows an optical mouse according to the prior art. According to this design, the light emitting element A1 of the optical mouse A is mounted on the surface of the circuit board A2 in a parallel manner. Light from the light emitting element A1 passes through the first refracting surface A31 of the refractor A3, to the second refracting surface A32, which refracts light from the first refracting surface A31 onto the contact surface B through a hole A41 in the bottom shell A4 of the optical mouse A. The circular arc surface A33 of the refractor A3 focuses reflected light from the contact surface B onto the sensor A5, which converts received image signal into electronic signal indicative of the direction and distance of movement of the optical mouse A on the contact surface B. This design of optical mouse A is still not satisfactory in function due to the following drawbacks.

1. Because light source is transmitted to the sensor A5 through at least three refracting actions, much light energy is lost in the way from the light emitting element A1 to the sensor A5.

2. Because light source is transmitted to the sensor A5 through at least three refracting actions, the light path is long. Long light path results in poor light source focusing effect and low luminance, thereby affecting the performance of the optical mouse A.

Therefore, it is desirable to provide an optical mouse that eliminates the aforesaid drawbacks.

### SUMMARY OF INVENTION

The present invention has been accomplished under the circumstances in view. It is therefore the main object of the present invention to provide an optical mouse, which effectively reduces loss of light source. It is another object of the present invention to provide an optical mouse, which greatly improves light source focusing effect. To achieve these and other objects of the present invention, the optical mouse comprises a housing holding a refractor and a circuit board carrying a light emitting element and a sensor. The refractor has a recessed receiving chamber that accommodates the light emitting element, a reflection surface for reflecting light from the light emitting element onto the contact surface that supports the housing, a light penetrating portion, and a circular arc surface for focusing light from the contact surface onto the sensor through the light penetrating portion.

### BRIEF DESCRIPTION OF DRAWINGS

FIG. 1 is an elevational view of an optical mouse according to the present invention.

FIG. 2 is an exploded view of the optical mouse according to the present invention.

FIG. 3 is a perspective view of a refractor for use in the optical mouse according to the present invention.

FIG. 4 is a side view in section of the refractor shown in FIG. 3.

FIG. 5 is a schematic sectional side view of the present invention, showing the action of the optical mouse.

FIG. 6 is a sectional side view of an optical mouse according to the prior art.

### DETAILED DESCRIPTION

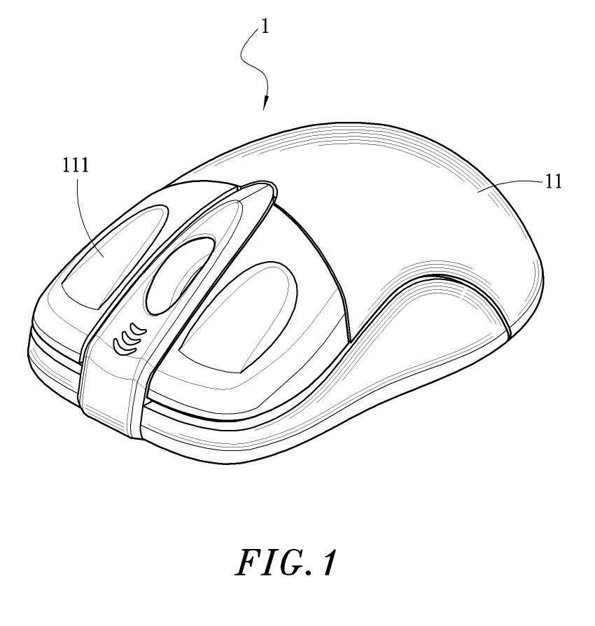

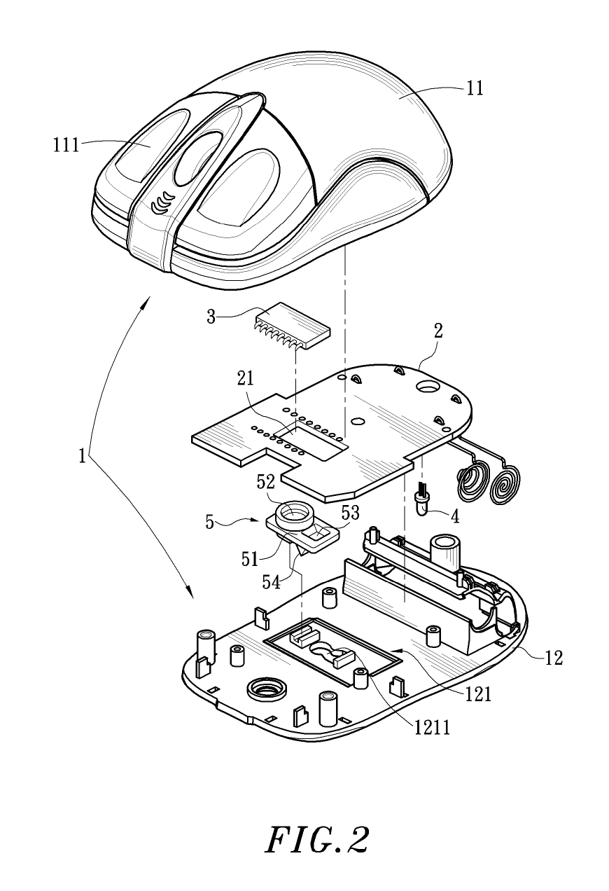

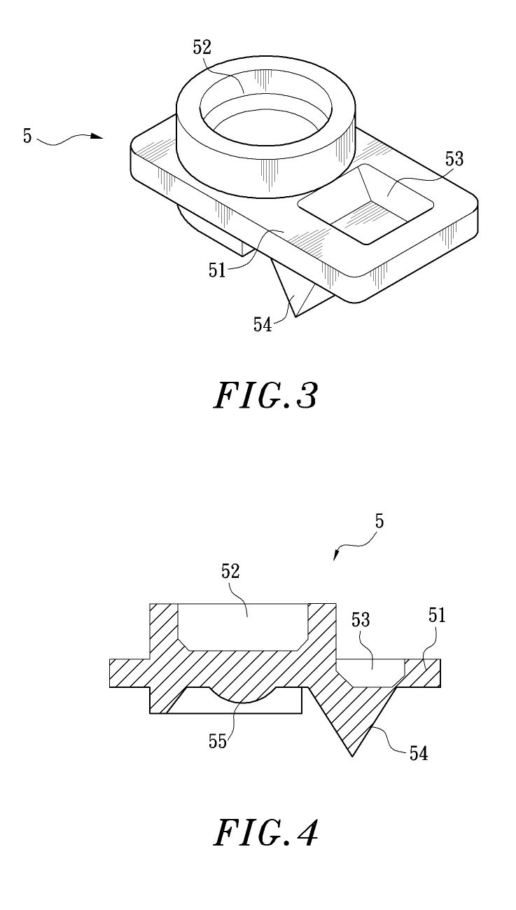

Referring to FIGS. 1˜4, an optical mouse is shown comprised of a housing 1, and a circuit board 2 mounted inside the housing 1. The housing 1 is comprised of a bottom shell 12, and a top cover shell 11, which is provided with a plurality of buttons 111. The circuit board 2 has an opening 21, a sensor 3 mounted on one side, namely, the top side over the opening 21, and a light emitting element 4 installed in the other side, namely, the bottom side. The bottom shell 12 of the housing 1 has a locating portion 121, and a through hole 1211 through the locating portion 121. A refractor 5 is positioned in the locating portion 121 of the bottom shell 12. The refractor 5 comprises a base 51. The base 51 has a light penetrating portion 52 and a recessed receiving chamber 53 at one side, namely, the top side, a reflection surface 54 and a circular arc surface 55 at the other side, namely, the bottom side corresponding to the through hole 1211 of the bottom shell 12 of the housing 1. The light emitting element 4 is suspended in the recessed receiving chamber 53 of the refractor 5 and perpendicularly aimed at the base 51 of the refractor 5. The sensor 3 has a signal pickup 31 suspending in the opening 21 of the circuit board 2 and aimed at the light penetrating portion 52 of the refractor 5.

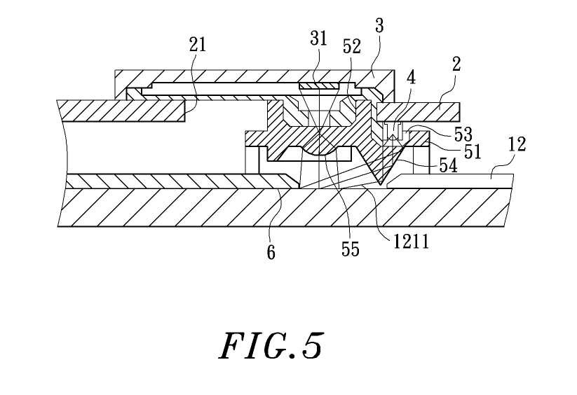

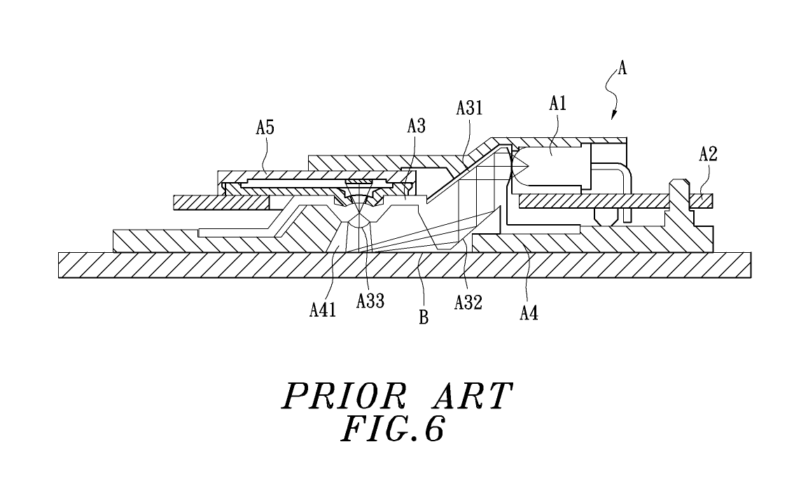

Referring to FIG. 5, light from the light emitting element 4 passes vertically downwards through the recessed receiving chamber 53 of the refractor 5 onto the reflection surface 54, which reflects the light through the through hole 1211 of the bottom shell 12 of the housing 1 onto the contact surface 6 that supports the optical mouse. And then, the contact surface 6 reflects incident light onto the circular arc surface 55 of the refractor 5 that focuses the light onto the signal pickup 31 of the sensor 3 through the light penetrating portion 52 of the refractor 5 and the opening 21 of the circuit board 2. By mans of continuously picking up reflected light from the contact surface 6, the signal pickup 31 of the sensor 3 obtains image signal from the contact surface 6, enabling the sensor 3 to converts obtained image signal into electronic signal indicative of the direction and distance of movement of the optical mouse.

As indicated above, the light emitting element 4 is suspended within the recessed receiving chamber 53 of the refractor 5, and perpendicularly aimed at the base 51 of the refractor 5. When refracted twice through the refractor 5, light source is transmitted to the signal pickup 31 of the sensor 3. This light path effectively reduces loss of light source, and improves light source focusing effect.

A prototype of optical mouse has been constructed with the features of FIGS. 1˜5. The optical mouse functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. An optical mouse comprising:
a housing, said housing comprising a bottom shell and a top cover shell covering said bottom shell;
a plurality of operation buttons installed in said top cover shell;
a circuit board mounted inside said housing;
a refractor mounted on said bottom shell inside said housing;
a light emitting element installed in said circuit board and adapted to emit light through said refractor onto a contact surface supporting said housing; and
a sensor installed in said circuit board and adapted to pick up light from the contact surface supporting said housing through said refractor and to convert received light into electronic signal indicative of direction and distance of said optical mouse;
wherein said refractor comprises a base, said base comprising a recessed receiving chamber adapted to accommodate said light emitting element, a reflection surface adapted to reflect light from said light emitting element onto the contact surface supporting said housing, a light penetrating portion, and a circular arc surface adapted to focus light from the contact surface supporting said housing onto said sensor through said light penetrating portion; said light emitting element is suspended in said recessed receiving chamber of said refractor and perpendicularly aimed at the base of said refractor.

2. The optical mouse as claimed in claim 1, wherein said circuit board has an opening; said sensor is suspended above said opening.

3. The optical mouse as claimed in claim 1, wherein said sensor has a signal pickup aimed at the light penetrating portion of said refractor.

4. The optical mouse as claimed in claim 1, wherein said bottom shell of said housing comprises a locating portion, and a through hole through said locating portion; said refractor is positioned in said locating portion of said bottom shell, keeping said reflection surface and said circular arc surface aimed at said through hole of said bottom shell.
